(19) United States
(12) Patent Application Publication
(10) Pub. No.: US 2010/0185332 A1
(43) Pub. Date: Jul. 22, 2010

(54) CLIMATE CONTROL SYSTEM FOR AN ENCLOSURE

(75) Inventors: Charles R. Schmidt, Boiling Springs, SC (US); Kristian Askegaard, Simpsonville, SC (US)

Correspondence Address: Nelson Mullins Riley & Scarborough LLP;IP Department, 100 North Tryon Street, 42nd Floor, Charlotte, NC, 28202-4000, US

(73) Assignee: DANTHERM AIR HANDLING, INC., Spartanburg, SC (US)

(21) Appl. No.: 12/690,742

(22) Filed: Jan. 20, 2010

Related U.S. Application Data
(60) Provisional application No. 61/146,237, filed on Jan. 21, 2009.

(51) Int. Cl. G05B 15/00; F25B 21/02

(52) U.S. Cl. 700/276; 62/3.2

(57) ABSTRACT

A system and method for climate control of an enclosure that includes two climate control systems configured to operate in conjunction to cool the enclosure. One climate control system may be configured to control the operation of the other climate control system. The climate control systems operate depending on the temperature of certain areas.

### CLAIM OF PRIORITY

The present application claims priority to U.S. Provisional Patent Application Ser. No. 61/146,237, filed Jan. 21, 2009, entitled “An Improved Climate Control System For An Enclosure,” the entire disclosure of which is hereby incorporated by reference for all purposes as if set forth verbatim herein.

### FIELD OF THE INVENTION

The present invention relates generally to a climate control system for an enclosure, such as an enclosure housing heat-sensitive equipment.

### BACKGROUND OF THE INVENTION

Electronic or other heat-sensitive equipment may be housed in various cabinets and other enclosures, such as cellular tower base cabinets, industrial power cabinets, and neighborhood wireline cabinets for telephone lines, cables transmitting television signals, or cables providing Internet access. The environment inside the enclosure surrounding the equipment typically must be maintained in a specific manner to prevent damage to the equipment. External factors, such as temperature, dust, salt, and humidity, can affect the equipment within the enclosure.

A climate control unit (“CCU”) may be used to control the enclosure's internal environment and may be further designed to reduce or eliminate the entry of some or all of the external contaminants. The CCU also attempts to maintain the temperature of the enclosure's internal environment at a predefined temperature or temperature range.

An above ambient CCU (“AACCU”), such as a heat exchanger, has been used to cool such electronic enclosures. An AACCU can lower the internal temperature of the enclosure but cannot reduce the temperature below ambient. In some instances, a below ambient CCU (“BACCU”), such as an air conditioner, replaces the AACCU as the CCU used to cool an enclosure. A BACCU can typically maintain an enclosure at a lower temperature than an AACCU because it is capable of cooling below the ambient temperature. However, the BACCU is usually accompanied by greater operational costs due to its higher energy consumption.

### SUMMARY OF THE INVENTION

The present invention recognizes and addresses the foregoing considerations, and others, of prior art construction and methods.

In this regard, one aspect of the present invention provides a climate control system for an enclosure comprising a first climate control unit connected to the enclosure and including a first control circuit configured to operate the first climate control unit, and a second climate control unit connected to the enclosure and including a second control circuit configured to operate the second climate control unit and operatively connected to the first control circuit, where the first control circuit instructs the second control circuit to operate the second climate control unit to cool the enclosure.

Another aspect of the present invention provides a method for cooling an enclosure comprising providing a first climate control unit connected to the enclosure, the first climate control unit comprising a first control circuit configured to operate the first climate control unit, and providing a second climate control unit connected to the enclosure, the second climate control unit comprising a second control circuit configured to operate the second climate control unit and operatively connected to the first control circuit, wherein the first control unit instructs the second control circuit to operate the second climate control unit to cool the enclosure.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a climate control system for an enclosure in accordance with an embodiment of the present invention;

FIG. 2 is a perspective view, partially cut away, of a climate control unit that may be utilized in the climate control system of FIG. 1;

FIG. 3 is a perspective view, partially cut away, of another climate control unit that may be utilized in the climate control system of FIG. 1; and

FIG. 4 is a flowchart representing an exemplary process performed by the climate control system of FIG. 1.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

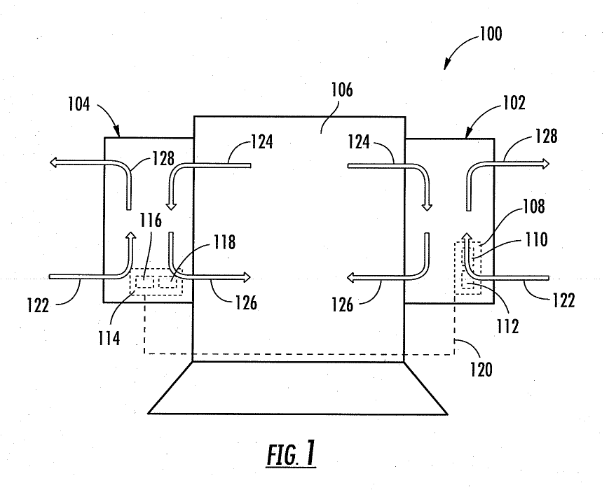

FIG. 1 illustrates a climate control system 100 in accordance with an embodiment of the present invention. Climate control system 100 comprises a first climate control unit (“CCU”) 102 and a second CCU 104 connected to an enclosure 106. Enclosure 106 will typically contain electrical or electronic equipment or various types of wiring. As one skilled in the art will appreciate, enclosure 106 protects its contents from external contaminants, such as dust, salt, and moisture.

CCU 102 includes a control board 108 configured to control the operation of CCU 102. Control board 108 comprises a processing device 110 operatively connected to readable medium 112. It should be understood that processing device 110 may be a processor, microprocessor, controller, microcontroller, or other processing device, while readable medium 112 may be any type of media or memory readable or otherwise accessible by the processing device, including random access memory (“RAM”), flash memory, erasable programmable read-only-memory or an “EPROM,” cache, registers, etc.

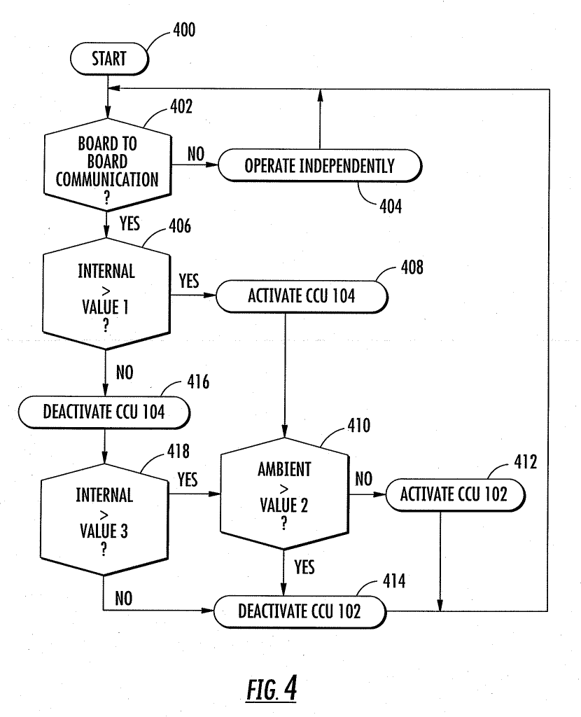

Similarly, CCU 104 comprises a control board 114 configured to operate CCU 104 and having a processing device 116 operatively connected to readable medium 118. In another embodiment, control boards 108 and 114 comprise a number of relays configured to control operation of respective CCUs 102 and 104 and to accomplish a climate control method such as that described in detail below with respect to FIG. 4.

A data path 120 operatively connects control boards 108 and 114, allowing the control boards to communicate or otherwise transmit data or instructions. In one embodiment, data path 120 is a wired serial communication channel, such as an RS-485 serial cable. Alternatively, data path 120 may be wired, wireless, or any other means suitable to allow control boards 108 and 114 to communicate. It should be understood that wireless encompasses wireless protocols and technologies suitable to facilitate communication between two devices, including Bluetooth, wireless fidelity (“Wi-Fi”) ad hoc network connections, and cellular signals.

In operation, CCUs 102 and 104 draw in air external to the CCUs (“ambient air”) near the base of the CCUs as indicated by arrows 122. Air from enclosure 106 (“internal air”) enters CCUs 102 and 104 near the top surface of the respective CCU indicated by arrows 124. Through a heat energy exchange process described in more detail below, heat energy is transferred from the internal air to the ambient air, thereby cooling the air returning to enclosure 106, as indicated by arrows 126, and heating the air returning to the area outside of the enclosure, as indicated by arrows 128.

Sensors adapted to measure the temperature of air are located in the path of flow of the air entering CCU 102 from enclosure 106 (“internal air temperature”) and air entering CCU 102 from the ambient (“ambient air temperature”). In the present embodiment, the temperature sensors are cable sensors adapted to measure the temperature of air passing the sensors, although it should be understood that any suitable sensors configured to measure the temperature of air may be used. As described below, control board 108 activates and deactivates CCU 102 based on an analysis of the temperatures measured by the sensors. The sensors may continue to measure the temperatures of the internal and ambient air even when CCU 102 is deactivated in order to perform methodology in accordance with the present invention. Likewise, control board 108 instructs control board 114 to activate and deactivate CCU 104 based on analysis of the temperatures.

It should be understood that CCU 102, CCU 104, and enclosure 106 are preferably constructed to preserve the internal air within the enclosure and within internal compartments of the CCUs. That is, the configuration of CCUs 102 and 104 in combination with enclosure 106 allows the exchange of heat energy between the ambient and internal air without mixing the two in order to prevent contamination of the internal air or the introduction of dust, sand, or other contaminants to the enclosure.

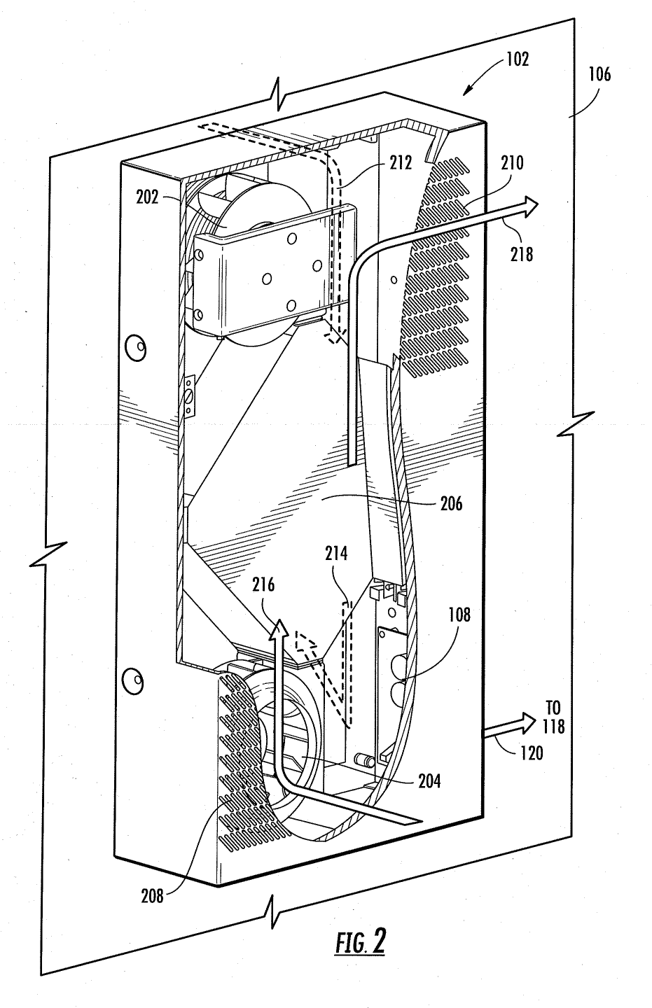

FIG. 2 illustrates CCU 102 connected to enclosure 106 in accordance with an embodiment of the present invention. In this embodiment, CCU 102 is a heat exchanger comprising an internal fan 202, an ambient fan 204, a heat exchange element 206, and external vents 208 and 210. Internal ports or other vents are also provided for ingress and egress of air internal to enclosure 106. Control board 108 is operatively connected to, and controls the operation of, fans 202 and 204. For example, fans 202 and 204 may be variable speed fans that operate at different speeds as commanded by control board 108. Control board 108 is also operatively connected to the sensors measuring the internal and ambient air temperatures. As noted above, data path 120 operatively connects control board 108 to control board 114 (FIG. 1).

In operation, internal fan 202 draws the internal air into CCU 102 indicated by arrow 212 via an internal port. The internal air then passes through heat exchange element 206 and back into enclosure 106 indicated by arrow 214 through another internal port defined between the enclosure and the CCU. Ambient air is drawn into CCU 102 through vent 208 by ambient fan 204 as indicated by arrow 216. The ambient air then passes over heat exchange element 206 and is returned to the exterior through vent 210 as indicated by arrow 218. Heat exchange element 206 facilitates the transfer of heat energy from the internal air passing through the element to the ambient air passing over the element.

Control board 108 preferably controls the activation and speed of fans 202 and 204 (and thus the operation of CCU 102) based on the difference between the internal air temperature and a predefined maximum desired temperature of the internal air (hereinafter “VALUE1” for purposes of explanation). For example, the greater the internal air temperature is in comparison to VALUE1, control board 108 increases the speed of fans 202 and 204. In contrast, if the temperature sensors indicate the ambient air is sufficiently greater than the internal air temperature, control board 108 deactivates fan 204 to prevent relatively warmer ambient air from being drawn into CCU 102. This prevents an exchange of heat from the ambient air to the internal air, opposite to the desired direction of heat exchange.

The operation and construction of heat exchanger 102 should be understood to those of ordinary skill in the relevant art and is, therefore, not described in more detail. It should be understood that CCU 102 may be any other CCU known to those in the art, including either an AACCU, such as a direct air cooling unit, one or more heat pipes, or a plurality of fins, or a BACCU, such as an air conditioning unit, a thermoelectric cooling unit, or a ground source cooling unit. Control board 108 instructs control board 114 (FIG. 1) to activate and deactivate CCU 104 (FIG. 1) via a process such as is described in detail below.

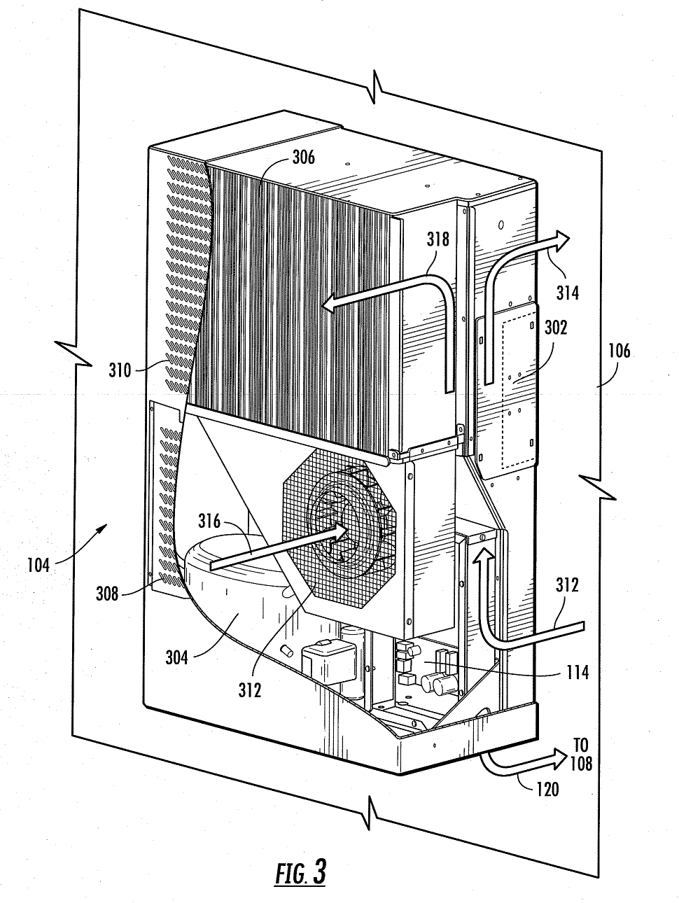

FIG. 3 illustrates CCU 104 connected to enclosure 106 in accordance with an embodiment of the present invention. In this embodiment, CCU 104 is an air-conditioning unit comprising components that perform a refrigeration cycle including an evaporator 302, a compressor 304, and a condenser 306. These refrigeration cycle components are interconnected by a set of pipes, through which a refrigerant flows. CCU 104 also comprises vents 308 and 310, as well as a fan 312. Each major component of the refrigeration cycle is operatively connected to control board 114 to allow the board to control the operation of the refrigeration cycle.

In operation, CCU 104 functions to cool the refrigerant within the pipes. An internal fan draws the internal air into CCU 104 via a port defined between the CCU and enclosure 106 as indicated by arrow 312. The internal air passes a temperature sensor and is directed over the pipes containing the cooled refrigerant. Heat energy is transferred from the internal air to the refrigerant, thereby cooling the internal air and heating the refrigerant. The cooled internal air is then returned to enclosure 106 as indicated by arrow 314 via another port defined between the enclosure and CCU 104.

Ambient air is drawn into CCU 104 by fan 312 through vent 308 as indicated by arrow 316. The heat dissipated from the refrigerant as it is cooled as a result of the refrigeration cycle is transferred to the ambient air, which then returns to the exterior of CCU 104 as indicated by arrow 318. Control board 114 activates and deactivates the refrigeration cycle components based on a comparison of the internal air temperature and VALUE1 when operating in an independent mode. That is, when the internal air temperature is greater than VALUE1, control board 114 activates CCU 104. As explained in more detail below, control board 114 activates the components based on instructions from control board 108 (FIG. 2) when operating in a dependent mode.

In one embodiment, compressor 304 is a variable speed compressor, the speed of which is managed by control board 114 based on either the temperature comparison (in an independent mode) or instructions received from control board 108 (FIG. 2, in a dependent mode). CCU 104 otherwise operates and is constructed in a manner understood by those of ordinary skill in the relevant art. It should be understood that CCU 104 may be any CCU understood by those of ordinary skill in the art, including both AACCUs and BACCUs.

As described above with respect to FIGS. 1, 2, and 3, control board 108 controls the operation of CCU 102, while control board 114 controls the operation of CCU 104. Control board 108 activates and deactivates CCU 102 in accordance with instructions stored on medium 112 and instructs control board 114 via data path 120 to activate and deactivate CCU 104 in accordance with instructions stored on medium 112 when operating in a dependent mode, as described below. It should be understood that the reverse may also be true—control board 114 activates and deactivates CCU 104 and instructs control board 108 via data path 120 to activate and deactivate CCU 102 when operating in a dependent mode—without departing from the scope of the present invention. That is, either control board may act as the primary control board. As noted above, control boards 108 and 114 may alternatively be comprised of relays that control the operation of the respective CCU.

FIG. 4 illustrates a method performed by control boards 108 and 114 in accordance with an exemplary embodiment of the present invention. Thus, referring to FIG. 4 with occasional reference to components shown in FIG. 1, the process begins at step 400, where power is supplied to CCUs 102 and 104. Additionally, processor 110 initializes VALUE1 to the maximum desired temperature of enclosure 106, which, in one exemplary embodiment, is 30° C. At step 402, control board 108 attempts to communicate with control board 114, which may be accomplished by any suitable method known to those of ordinary skill in the art such as a ping query. In the presently-described embodiment, both control boards repeatedly send outgoing signals and listen for incoming signals, which allow the boards to synchronize communications. If control board 108 is unable to establish a connection with control board 114, CCUs 102 and 104 are set to operate independently, at step 404. Process flow loops back to step 402 and the process then repeats.

In an independent mode, processor 110 of control board 108 activates and deactivates CCU 102 in accordance with the instructions stored on medium 112. This includes activating and controlling the speed of fans 202 and 204 (FIG. 2) based on the internal and ambient air temperatures. Likewise, processor 116 of control board 114 activates and deactivates CCU 104 in accordance with the instructions stored on medium 118, which may include controlling the speed of compressor 304 (FIG. 3). CCUs 102 and 104 operate independently until the control boards have established the communication link.

If communication between the boards is established at step 402, process flow continues to step 406, where control board 108 determines whether the internal air temperature is greater than VALUE1. If so, process flow proceeds to step 408, where control board 108 instructs control board 114 to activate CCU 104. Process flow then proceeds to step 410, where control board 108 determines whether the ambient air temperature is greater than a second predefined value (hereinafter “VALUE2,” for purposes of explanation). In an exemplary embodiment, VALUE2 is the result of an efficiency offset subtracted from VALUE1. The goal of the efficiency offset is to compensate for any discrepancies in the measurement of the temperature of the ambient air drawn into CCU 102 and the actual temperature of the ambient air. In the current embodiment, the offset is 5° C.

If the ambient air temperature is not greater than VALUE2, process flow proceeds to step 412, where control board 108 activates CCU 102. If the ambient air temperature is greater than VALUE2, this indicates that use of CCU 102 would be inefficient in the current scenario. Accordingly, process flow proceeds to step 414, where control board 108 deactivates CCU 102.

If the internal air temperature is not greater than VALUE1 as determined at step 406, then process flow proceeds to step 416, where control board 108 instructs control board 114 to deactivate CCU 104. At step 418, the internal air temperature is compared to a third predefined value (hereinafter “VALUE3,” for purposes of explanation) to determine if the internal air temperature is sufficiently low that CCU 102 may be deactivated. If the internal air temperature is not greater than VALUE3, control board 108 deactivates CCU 102 at step 414. If the internal air temperature is greater than VALUE3, process flow proceeds to step 410 and continues in the manner described above. VALUE3 is defined by the user of climate control system 100 and may depend on the enclosure's contents and the external environment of system 100. For example, the user may desire CCU 102 to operate even in relative low temperatures and may thus set VALUE3 to be equal to a very low temperature.

It should also be understood that climate control system 100 may be configured so that CCU 102 is activated if the internal air temperature is not greater than VALUE1 regardless of the specific internal air temperature. That is, the internal air temperature is not compared to VALUE3 at step 418 in order to determine whether CCU 102 may be deactivated. In this embodiment, step 418 is omitted so that process flow proceeds from step 416 directly to step 410 to determine if use of CCU 102 in that scenario is efficient.

The process described above is repeated as illustrated in FIG. 4 by the process proceeding from steps 404, 412, or 414 to step 402. In another embodiment, once communication between control boards 108 and 114 has been established, the process flow does not return to step 402, but proceeds from steps 412 and 414 to step 406. The temperature sensors continuously measure the internal and ambient air temperatures, and the above process is continuously repeated. It should be understood, however, that climate control system 100 may be configured to perform the process of FIG. 4 and to remeasure the temperatures following predefined intervals of time.

The terms “activate” and “deactivate” as used above should be understood to indicate that the respective CCU operates in the manner described above with respect to FIGS. 1, 2, and 3. In addition, if the process set forth in FIG. 4 proceeds to a step requiring activation of a CCU, such as steps 408 and 412, while the CCU is already operating, the CCU continues to operate. Similarly, if the process proceeds to a step requiring deactivation of a CCU, such as steps 414 and 416, while the CCU is already deactivated or otherwise not operating, the CCU continues to remain deactivated.

In another embodiment, and with reference to FIG. 1, one or more additional CCUs are attached to enclosure 106. Each of the one or more additional CCUs may be either an AACCU or a BACCU and comprises a control board or relays configured to control the operation of the additional CCU. The control board of the additional CCU is operatively connected to control board 108 so that control board 108 instructs it to activate and deactivate the additional CCU based on an analysis of the internal and ambient air temperatures in a manner similar to that described above with respect to FIG. 4.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. For example, aspects of one embodiment may be combined with aspects of other embodiments to yield still further embodiments. Therefore, it is contemplated that any and all such embodiments are included in the present invention as may fall within the scope and spirit thereof.

The invention claimed is:

1. A climate control system for an enclosure comprising:
a first climate control unit connected to the enclosure and including a first control circuit configured to operate the first climate control unit; and
a second climate control unit connected to the enclosure and including a second control circuit configured to operate the second climate control unit and operatively connected to the first control circuit,
wherein the first control circuit instructs the second control circuit to control the operation of the second climate control unit to cool the enclosure.

2. The system as claimed in claim 1, wherein the first climate control unit is an above ambient climate control unit.

3. The system as claimed in claim 2, wherein the above ambient climate control unit is a heat exchanger.

4. The system as claimed in claim 2, wherein the above ambient climate control unit is one selected from the group consisting of a direct air cooling unit, at least one heat pipe, and a plurality of fins.

5. The system as claimed in claim 2, wherein the second climate control unit is a below ambient climate control unit.

6. The system as claimed in claim 5, wherein the above ambient climate control unit is a heat exchanger, and the below ambient climate control unit is an air conditioner.

7. The system as claimed in claim 1, wherein the first climate control unit is a below ambient climate control unit.

8. The system as claimed in claim 7, wherein the below ambient climate control unit is an air conditioner.

9. The system as claimed in claim 7, wherein the below ambient climate control unit is one selected from the group consisting of a thermoelectric cooling unit and a ground source cooling unit.

10. The system as claimed in claim 1 wherein:
the first control circuit comprises readable memory including program instructions and a processing device operatively connected to the readable memory and adapted to perform a method for cooling the enclosure when the processor executes the program instructions, the method comprising the steps of:
activating the second climate control unit when the temperature of air entering the first climate control unit from the enclosure (the internal air temperature) is greater than a first predefined temperature; and
activating the first climate control unit when the internal air temperature is greater than the first predefined temperature and the temperature of the air entering the first climate control unit from an area ambient the first climate control unit (the ambient air temperature) is greater than a second predefined value.

11. The system as claimed in claim 6 wherein:
the first control circuit comprises readable memory including program instructions and a processing device operatively connected to the readable memory and adapted to perform a method for cooling the enclosure when the processor executes the program instructions, the method comprising the steps of:
activating the second climate control unit when the temperature of air entering the first climate control unit from the enclosure (the internal air temperature) is greater than a first predefined temperature; and
activating the first climate control unit when the internal air temperature is greater than the first predefined temperature and the temperature of the air entering the first climate control unit from an area ambient the first climate control unit (the ambient air temperature) is greater than a second predefined value.

12. The system as claimed in claim 10, wherein the method further comprising the step of operating the first climate control unit independently of the second climate control unit when the first control circuit is unable to communicate with the second control circuit.

13. The system as claimed in claim 10, wherein the first and second predefined temperatures are equal.

14. The system as claimed in claim 10, wherein the first predefined temperature is equal to the second predefined temperature minus a predetermined delta.

15. A method for cooling an enclosure comprising:
providing a first climate control unit connected to the enclosure, the first climate control unit comprising a first control circuit configured to operate the first climate control unit; and
providing a second climate control unit connected to the enclosure, the second climate control unit comprising a second control circuit configured to operate the second climate control unit and operatively connected to the first control circuit, wherein the first control unit instructs the second control circuit to control the operation of the second climate control unit to cool the enclosure.

16. The method as claimed in claim 15 further comprising:
independently operating the first climate control unit when the first control circuit does not receive a signal from the second control circuit; and
independently operating the second climate control unit when the second control circuit does not receive a signal from the first control circuit.

17. The method as claimed in claim 15 further comprising deactivating the first climate control unit and activating the second climate control unit when the temperature of air ambient to the enclosure is greater than a first predefined temperature and the temperature of air internal to the enclosure is greater than a second predefined value.

18. The method as claimed in claim 15 further comprising activating both the first and second climate control units when the temperature of air ambient to the enclosure is less than or equal to a first predefined temperature and the temperature of the air internal to the enclosure is greater than a second predefined temperature.

19. The method as claimed in claim 15 further comprising deactivating the second climate control unit and activating the first climate control unit when the temperature of air ambient to the enclosure is less than or equal to a first predefined temperature and the temperature of air internal to the enclosure is less than or equal to a second predefined temperature.

20. The method as claimed in claim 17 further comprising activating both the first and second climate control units when the temperature of air ambient to the enclosure is less than or equal to the first predefined temperature and the temperature of the air internal to the enclosure is greater than the second predefined temperature.

21. The method as claimed in claim 20 further comprising deactivating the second climate control unit and activating the first climate control unit when the temperature of air ambient to the enclosure is less than or equal to the first predefined temperature and the temperature of air internal to the enclosure is less than or equal to the second predefined temperature.

22. The method as claimed in claim 15, wherein the first climate control unit is an above ambient climate control unit; and the second climate control unit is a below ambient climate control unit.

23. The method as claimed in claim 22, wherein the first climate control unit is a heat exchanger; and the second climate control unit is an air conditioner.

24. The method as claimed in claim 15, wherein the first climate control unit is a first air conditioner; and the second climate control unit is a second air conditioner.
